(19) United States
(12) Patent Application Publication
(10) Pub. No.: US 2014/0152120 A1
(43) Pub. Date: Jun. 5, 2014

(54) ELECTRONIC DEVICE AND SYSTEM

(71) Applicant: NEC TOKIN CORPORATION, Sendai-shi, Miyagi (JP)

(72) Inventors: Junetsu Urata, Sendai-shi (JP); Yuki Takahashi, Sendai-shi (JP); Koji Sato, Sendai-shi (JP)

(21) Appl. No.: 14/131,414

(22) PCT Filed: Oct. 24, 2012
(86) PCT No.: PCT/JP2012/077435

§ 371 Date: Jan. 7, 2014

(30) Foreign Application Priority Data
Dec. 22, 2011 (JP) 2011-281777
Aug. 6, 2012 (JP) 2012-174360

(51) Int. Cl. H01F 38/14; H02H 3/02

(52) U.S. Cl. CPC H01F 38/14; H02H 3/02
USPC 307/104

(57) ABSTRACT

This primary-side device (electronic device) is provided with a first coil for non-contact power transmission, a second coil for communication, a protection circuit containing an intermediate tap of the second coil, and a control circuit. The control circuit sends a control signal to the protection circuit when the first coil is used to transmit power. The protection circuit opens the second coil when the control signal is received.

### TECHNICAL FIELD

This invention relates to an electric device comprising a first coil for non-contact power transmission and a second coil for communication. This invention also relates to a system comprising the electric device.

### BACKGROUND ART

For example, Patent Document 1 discloses a reader/writer which is an electric device having a plurality of antenna coils. Each of the antenna coils of the reader/writer of Patent Document 1 is connected in series to a switch so that the antenna coils are prevented from interfering with one another. When one of the antenna coils is to be activated, the switches connected to the other antenna coils are turned off.

For another example, Patent Document 2 discloses a primary device (electric power transmitting means) which is an electric device comprising a first coil for non-contact power transmission and a second coil for communication.

### PRIOR ART DOCUMENTS

### Patent Document(s)

Patent Document 1: JP A 2006-268627

Patent Document 2: JPA 2010-130835

### SUMMARY OF INVENTION

### Technical Problem

The mutual interference among the antenna coils described in Patent Document 1 might occur also in the primary device of Patent Document 2. However, in order for the technique disclosed in Patent Document 1 to be applied to the primary device of Patent Document 2, it is necessary to provide a component such as a mechanical relay, a Photo-MOS relay or a balun. Accordingly, it is difficult to practically realize a low-cost structure having a reduced size.

It is therefore an object of the present invention to provide an electric device comprising a first coil for non-contact power transmission and a second coil for communication, wherein the electric device can reduce the undesirable mutual interference, and wherein the electric device has a reduced size structure feasible by low-cost.

### Solution to Problem

The coil for power transmission and the coil for communication have different power levels from each other. Accordingly, when the coil for power transmission and the coil for communication interfere with each other, a communication circuit connected to the coil for communication and a power transmission circuit connected to the coil for power transmission are affected differently from each other. More specifically, when the coil for communication works, the power transmission circuit is not very largely affected. On the other hand, when the coil for power transmission works, the communication circuit is largely affected. The present invention therefore mainly prevents the coil for power transmission and the coil for communication from interfering with each other when the coil for power transmission works.

Specifically, one aspect of the present invention provides an electronic device comprising a first coil for non-contact power transmission, a second coil for communication, a protection circuit which includes a center tap of the second coil and opens the second coil upon receiving a control signal, and control-signal sending means which sends the control signal to the protection circuit when the first coil is used to transmit electric power.

Another aspect of the present invention provides a system comprising the electronic device and a secondary device including a circuit configured to receive electric power from the electronic device and another circuit configured to communicate the electronic device.

### ADVANTAGEOUS EFFECTS OF INVENTION

According to the present invention, when the first coil is used to transmit the electric power, the control signal is sent to the protection circuit to open the second coil. Accordingly, the interference can be efficiently reduced by a minimal structure.

Moreover, the protection circuit is configured to include the center tap of the second coil for communication. By fixing an electric potential of the center tap, the protection circuit can be formed of a low-cost FET without using a balun or the like.

An appreciation of the objectives of the present invention and a more complete understanding of its structure may be had by studying the following description of the preferred embodiment and by referring to the accompanying drawings.

### BRIEF DESCRIPTION OF DRAWINGS

FIG. 1 is a block diagram schematically showing a system according to a first embodiment of the present invention.

FIG. 2 is a block diagram schematically showing a primary device (electronic device) of the system of FIG. 1.

FIG. 3 is a circuit diagram showing a specific configuration of a protection circuit of the primary device (electronic device) of FIG. 2.

FIG. 4 is a block diagram schematically showing a primary device (electronic device) according to a second embodiment of the present invention.

FIG. 5 is a block diagram schematically showing a primary device (electronic device) according to a third embodiment of the present invention.

FIG. 6 is a circuit diagram showing a specific configuration of a voltage detection circuit of the primary device (electronic device) of FIG. 5.

FIG. 7 is a block diagram schematically showing a primary device (electronic device) according to a fourth embodiment of the present invention.

FIG. 8 is a block diagram schematically showing a primary device (electronic device) according to a fifth embodiment of the present invention.

### DESCRIPTION OF EMBODIMENTS

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### First Embodiment

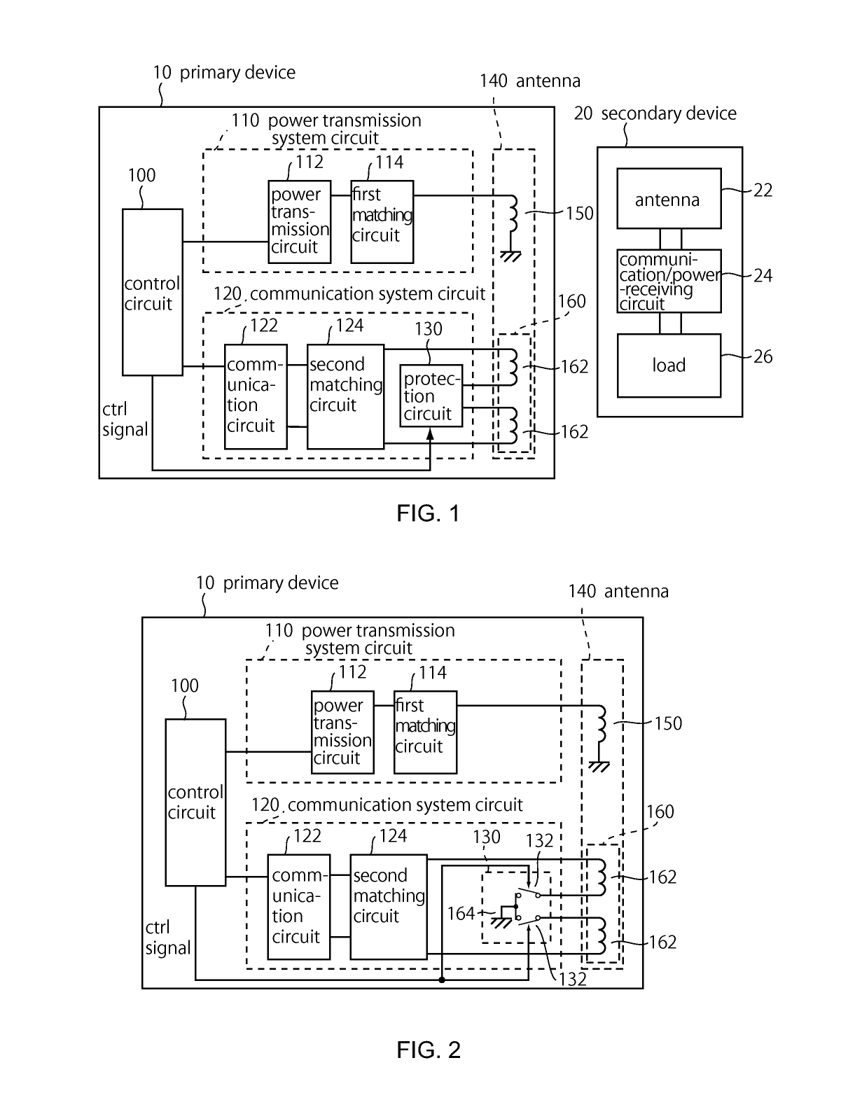

Referring to FIG. 1, a system according to a first embodiment of the present invention comprises a primary device (electronic device) 10 and a secondary device 20. The primary device 10 is configured to transmit electric power to the secondary device 20 and to communicate with the secondary device 20. On the other hand, the secondary device 20 is configured to receive the electric power from the primary device 10 and to communicate with the primary device 10. More specifically, the secondary device 20 comprises an antenna 22, a communication/power-receiving circuit 24 and a load 26. The load 26 according to the present embodiment is a battery. The communication/power-receiving circuit 24 can communicate with the primary device 10 via the antenna 22. Moreover, the communication/power-receiving circuit 24 can receive the electric power, which is transmitted from the primary device 10, via the antenna 22 to charge the load 26 with the electric power. In other words, the secondary device 20 includes a circuit configured to receive the electric power from the primary device 10 and another circuit configured to communicate with the primary device 10.

The primary device 10 according to the present embodiment comprises a control circuit 100, a power transmission system circuit 110 connected to the control circuit 100, a communication system circuit 120 connected to the control circuit 100 and an antenna 140 connected to the power transmission system circuit 110 and the communication system circuit 120. The primary device 10 makes the power transmission system circuit 110 work under control of the control circuit 100 to transmit the electric power to the secondary device 20. Moreover, the primary device 10 makes the communication system circuit 120 work under control of the control circuit 100 to communicate with the secondary device 20.

In the present embodiment, a frequency of a power wave upon the transmission of the electric power is equal to a frequency of a carrier wave upon the communication. More specifically, each of the frequency of the power wave and the frequency of the carrier wave is 13.56 MHz band. In addition, an antenna power of the power wave which is transmitted during the transmission of the electric power is larger than another antenna power during the communication. More specifically, the antenna power of the power wave which is transmitted during the transmission of the electric power is equal to or more than 5 W, while the antenna power during the communication is equal to or less than 1 W.

Referring to FIG. 1, the antenna 140 includes a first coil 150 for the non-contact power transmission and a second coil 160 for the communication. The first coil 150 is connected to the power transmission system circuit 110. The second coil 160 is connected to the communication system circuit 120. The second coil 160 is equally divided to have two coil portions 162.

The power transmission system circuit 110 includes a power transmission circuit 112 connected to the control circuit 100, and a first matching circuit 114 connected (i.e. provided) between the power transmission circuit 112 and the first coil 150. The power transmission circuit 112 is a circuit for the power transmission. In detail, under control of the control circuit 100, the power transmission circuit 112 generates a carrier wave and transmits the electric power to the secondary device 20 by using the generated carrier wave. The first matching circuit 114 is a circuit for matching the power transmission circuit 112 and the first coil 150 with each other.

The communication system circuit 120 includes a communication circuit 122 connected to the control circuit 100, a second matching circuit 124 connected (i.e. provided) between the communication circuit 122 and the second coil 160, and a protection circuit 130 connected to the second coil 160 and the control circuit 100. The communication circuit 122 communicates with the secondary device 20 under control of the control circuit 100. In detail, the communication circuit 122 generates a carrier wave and communicates by using the generated carrier wave. The second matching circuit 124 is a circuit for matching the communication circuit 122 and the second coil 160 with each other. According to the present embodiment, the second matching circuit 124 is connected to opposite ends of the second coil 160. In detail, an end of the second matching circuit 124 is connected to an end of one of the coil portions 162, while another end of the second matching circuit 124 is connected to an end of a remaining one of the coil portions 162.

The protection circuit 130 is connected to another end of each of the coil portions 162, or the end which is not connected to the second matching circuit 124. In detail, the protection circuit 130 is configured to include a middle point of the second coil 160, wherein the middle point is a center tap 164 which is located between the two coil portions 162 as described later. The protection circuit 130 is configured to cut off a connection between the two coil portions 162 or to open the second coil 160 upon receiving a control signal from the control circuit 100.

As shown in FIG. 2, the protection circuit 130 according to the present embodiment includes two switches 132 each of which is connected between one of the two coil portions 162 and the center tap 164 (i.e. the middle point of the second coil 160). Each of the switches 132 is configured to be turned off in response to the control signal sent from the control circuit 100. The center tap 164 of the second coil 160 is supplied with a fixed electric potential. More specifically, the center tap 164 of the second coil 160 according to the present embodiment is connected to the ground.

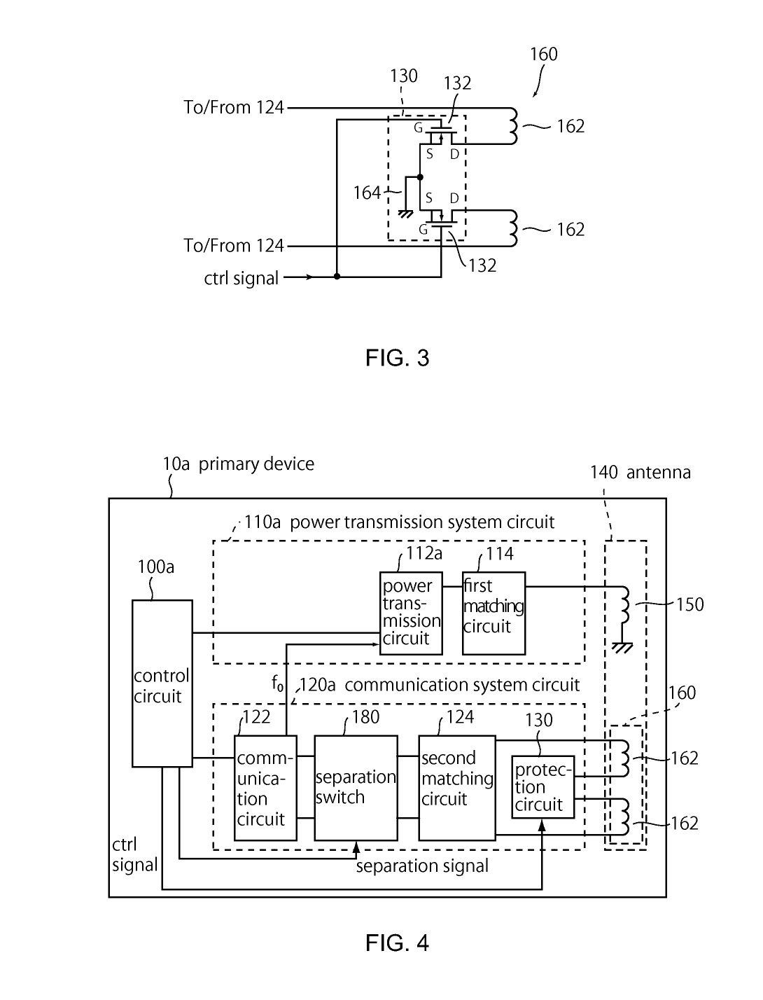

For example, as shown in FIG. 3, the aforementioned protection circuit 130 can be formed by using two Nch (n-channel) FETs as the switches 132. In other words, each of the switches 132 of the protection circuit 130 illustrated in FIG. 3 includes the n-channel FET having a source, a drain and a gate. The drains of the two FETs of the protection circuit 130 illustrated in FIG. 3 are connected to the corresponding coil portions 162, respectively. The sources of the two FETs are connected to each other at a connection point. The center tap 164 extends from the connection point to be connected to the ground. The gates of the FETs are connected to the control circuit 100 so that the control circuit 100 can input the control signal into the gates of the FETs as necessary. Since the protection circuit 130 is configured as described above, a source potential of the FET is fixed to the ground. Accordingly, the FET can be reliably turned on by applying a voltage of predetermined value to the gate, wherein the predetermined value can be determined only by a threshold of the FET. The protection circuit 130 may be formed by using a bipolar transistor of NPN type instead of the Nch FET. Moreover, the protection circuit 130 may be formed by using a Pch FET or a bipolar transistor of PNP type as the switch 132. In this case, the center tap 164 may be connected, for example, to a power source. In other words, the center tap 164 may be supplied with a voltage of the power source. When the electric potential of the center tap 164 is thus fixed, the protection circuit 130 and a control system of the protection circuit 130 can be more simply formed by lower-cost.

Under an electric power transmission mode (power transmission mode), the control circuit 100 makes the power transmission circuit 112 transmit the electric power from the first coil 150 to the secondary device 20. Under a communication mode, the control circuit 100 makes the communication circuit 122 communicate with the secondary device 20 via the second coil 160. Under the electric power transmission mode, the control circuit 100 according to the present embodiment sends the control signal to the protection circuit 130 to turn off the switches 132 to open the second coil 160. In other words, the control circuit 100 is configured to control the power transmission circuit 112 and the communication circuit 122 so that the first coil 150 transmits the electric power and that the communication circuit 122 communicates via the second coil 160.

As described above, according to the present embodiment, the second coil 160 is opened under the electric power transmission mode. Accordingly, it can be avoided that the first coil 150 interferes the second coil 160 during the transmission of the electric power to damage the communication circuit 122. In other words, the communication circuit 122 can be protected.

As can be understood from the above explanation, the primary device 10 comprises control-signal sending means which sends the control signal to the protection circuit 130 when the first coil 150 is used to transmit the electric power. The control-signal sending means according to the present embodiment is the control circuit 100. In other words, the control circuit 100 according to the present embodiment functions as a circuit for the control-signal sending means.

According to the aforementioned embodiment, the frequency of the carrier wave upon the transmission of the electric power and the frequency of the carrier wave upon the communication are equal to each other. The present invention is especially effective in the case where the frequency of the carrier wave upon the transmission of the electric power and the frequency of the carrier wave upon the communication are equal to each other. However, an applicable scope of the present invention is not limited to such case. Even when the frequency of the carrier wave upon the transmission of the electric power and the frequency of the carrier wave upon the communication are different from each other, the communication circuit 122 without the protection circuit 130 is applied with a large voltage in some cases. In such cases, although the frequencies of the carrier waves for the transmission of the electric power and the communication are different from each other, the communication circuit 122 can be properly protected by applying the present invention.

In the aforementioned embodiment, explanation is made about the primary device 10 as an example. However, the present invention is applicable to a device other than the primary device 10. For example, when the secondary device 20 has a coil for a non-contact power transmission and another coil for communication; that is to say, in a case where a communication circuit is provided, it is preferable that the communication circuit of the secondary device 20 be protected similar to the communication circuit 122 of the primary device 10 according to the aforementioned first embodiment. In such case, the secondary device 20 may be provided with a protection circuit to protect the communication circuit of the secondary device 20.

The protection circuit 130 according to the aforementioned embodiment includes the two switches 132 which are arranged symmetrically relative to the center tap 164. However, the protection circuit 130 may be configured differently, provided that the protection circuit 130 has at least two switches, which are the switches 132 or the other switches. For example, the protection circuit 130 may be further provided with a single switch or a plurality of switches connected in parallel to each of the switches 132. In other words, the protection circuit 130 may have switch portions each of which is formed of a plurality of switches connected in parallel to one another. In this case, the protection circuit 130 may be formed by arranging a plurality of the switch portions symmetrically to one another relative to the center tap 164.

### Second Embodiment

Referring to FIGS. 1 and 4, a primary device (electronic device) 10a according to a second embodiment of the present invention is a modification of the primary device 10 according to the aforementioned first embodiment. In FIG. 4, components same as the components illustrated in FIG. 1 are identified by reference signs same as those in FIG. 1. In the following explanation, explanation about the same components is omitted while explanation is mainly made about some points different from the aforementioned first embodiment.

As shown in FIG. 4, the primary device 10a according to the present embodiment comprises a control circuit 100a, a power transmission system circuit 110a connected to the control-circuit 100a, a communication system circuit 120a connected to the control circuit 100a. The antenna 140 is connected to the power transmission system circuit 110a and the communication system circuit 120a. The power transmission system circuit 110a includes a power transmission circuit 112a which is different from the power transmission circuit 112 (see FIG. 1) according to the first embodiment. Similar to the first embodiment, the communication circuit 122 of the communication system circuit 120a can generate a carrier wave f₀. In detail, the communication circuit 122 includes a generator which generates the carrier signal fₒ. The power transmission circuit 112a is configured to receive the carrier signal f₀ from the communication circuit 122 to transmit the electric power by using the carrier signal f₀. In other words, during the transmission of the electric power, the power transmission circuit 112a transmits the electric power by using the carrier signal f₀ generated by the communication circuit 122. Accordingly, the primary device 10a is not provided with such a generator that generates a carrier signal used only by the power transmission circuit 112a, or a generator other than the generator included in the communication circuit 122.

As can be understood from the aforementioned explanation, the communication circuit 122 according to the present embodiment is required to generate the carrier signal f₀ even under the electric power transmission mode. Accordingly, the control circuit 100a controls the communication circuit 122 so that the generator of the communication circuit 122 works even under the electric power transmission mode.

According to the present embodiment, under the electric power transmission mode, the carrier signal f₀ generated by the communication circuit 122 is required to be prevented from being supplied to the second coil 160. Accordingly, the communication system circuit 120a according to the present embodiment further includes a separation switch 180 connected between the communication circuit 122 and the second matching circuit 124.

The separation switch 180 according to the present embodiment is connected to the control circuit 100a. When the separation switch 180 receives a separation signal from the control circuit 100a, the separation switch 180 disconnects and separates the communication circuit 122 from the second matching circuit 124.

Under the electric power transmission mode (power transmission mode), the control circuit 100a makes the power transmission circuit 112 transmit the electric power from the first coil 150 to the secondary device 20 by using the carrier signal f₀ generated by the communication circuit 122. Moreover, the control circuit 100a under the power transmission mode sends the separation signal to the separation switch 180 to disconnect the connection between the communication circuit 122 and the second matching circuit 124. Moreover, the control circuit 100a under the power transmission mode sends the control signal to the protection circuit 130 to open the second coil 160.

Since the primary device 10a is configured as described above, one of the generators for generating the carrier signals can be omitted.

As can be understood from the above explanation, the primary device 10a comprises separation-signal sending means which sends the separation signal to the separation switch 180 for disconnecting the connection between the communication circuit 122 and the second matching circuit 124. The separation-signal sending means according to the present embodiment is the control circuit 100a. In other words, the control circuit 100a according to the present embodiment functions as a circuit for the separation-signal sending means.

As described above, the primary device 10 according to the first embodiment comprises only the control circuit 100 as the control-signal sending means. Similarly, the primary device 10a according to the second embodiment comprises only the control circuit 100a as the control-signal sending means and the separation-signal sending means. However, the primary device 10 may comprise control-signal sending means other than the control circuit 100 while comprising the control circuit 100 as one circuit for the control-signal sending means. Similarly, the primary device 10a may comprise control-signal sending means and separation-signal sending means other than the control circuit 100a. More specifically, the control circuit 100 or the control circuit 100a may send the control signal, namely, a first control signal which is a kind of the control signal, and the separation signal, namely, a first separation signal which is a kind of the separation signal, as described above, while the other circuit may send a second control signal, which is another kind of the control signal, and a second separation signal which is another kind of the separation signal.

### Third Embodiment

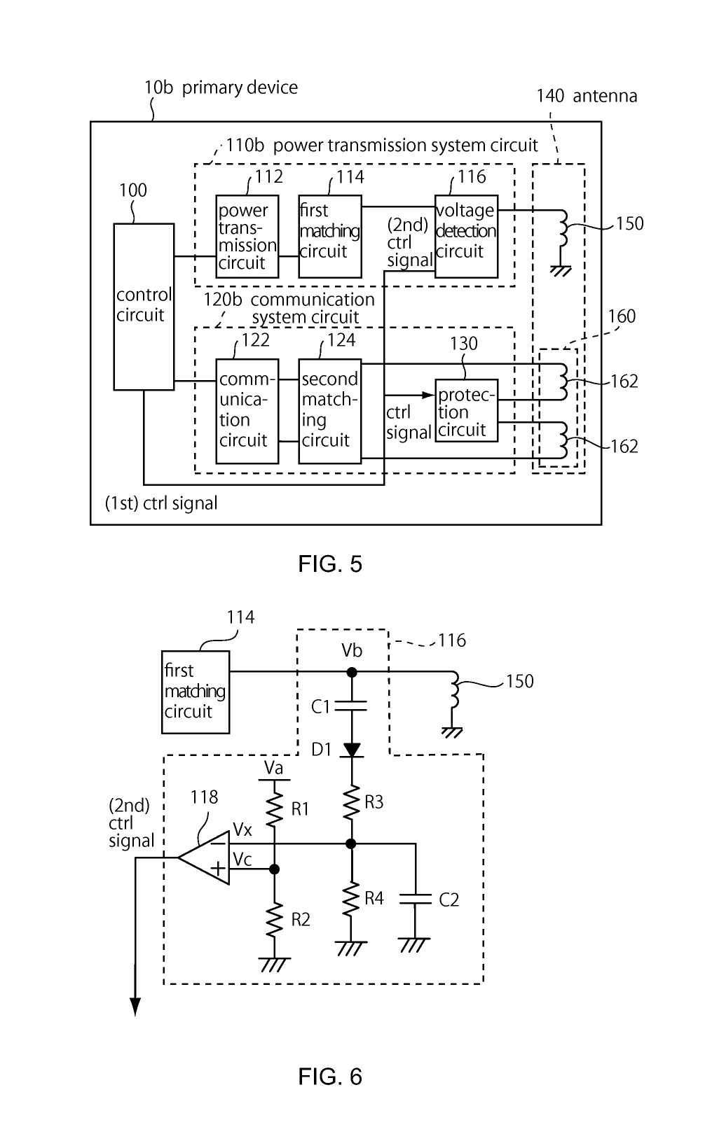

Referring to FIGS. 1 and 5, a primary device (electronic device) 10b according to a third embodiment of the present invention is another modification of the primary device 10 according to the aforementioned first embodiment. In FIG. 5, components same as the components illustrated in FIG. 1 are identified by reference signs same as those in FIG. 1. In the following explanation, explanation about the same components is omitted while explanation is mainly made about some points different from the aforementioned first embodiment.

As shown in FIG. 5, the primary device 10b according to the present embodiment comprises a power transmission system circuit 110b and a communication system circuit 120b slightly different from the power transmission system circuit 110 and the communication system circuit 120. In detail, the power transmission system circuit 110b further includes a voltage detection circuit 116. The voltage detection circuit 116 is connected to the first matching circuit 114, the first coil 150 and the protection circuit 130. The voltage detection circuit 116 according to the present embodiment can detect a voltage induced in the first coil 150. The voltage detection circuit 116 sends the second control signal, which is another kind of the control signal, to the protection circuit 130 of the communication system circuit 120b depending on the detected voltage. In other words, the primary device 10b according to the present embodiment comprises the voltage detection circuit 116 which functions as another circuit for the control-signal sending means.

The thus-configured primary device 10b can passively protect the communication circuit 122 from its external environment. For example, when the primary device 10b is placed in such an environment that the primary device 10b receives strong electric power from outside (e.g. when another device transmitting electric power is located in the vicinity of the primary device 10b), the protection circuit 130 can be activated depending on a voltage which is induced in the first coil 150 by the strong electric power from outside.

As shown in FIG. 6, the voltage detection circuit 116 can be formed of, for example, resistors (R1, R2, R3 and R4), capacitors (C1 and C2), a rectifier element D1 and a voltage comparator 118. A reference voltage Vc due to a voltage (Va) of a power source is input into one of input terminals of the voltage comparator 118. A variation voltage (Vx) due to a voltage (Vb) induced in the first coil 150 is input into a remaining one of the input terminals of the voltage comparator 118. The voltage comparator 118 outputs the control signal, namely, the second control signal, when the variation voltage (Vx) is larger than the reference voltage Vc. In other words, the voltage detection circuit 116 outputs the second control signal when a voltage (predetermined voltage) over a predetermined threshold is induced in the first coil 150. The condition where the second control signal is output can be variously designed to be suitable to the environment where the primary device 10b is used, for example, by changing the voltage (Va) of the power source.

As can be seen from FIG. 6, the protection circuit 130 can output the second control signal not only depending on the voltage induced in the first coil 150 by the outside strong electric power but also depending on a voltage generated in the first coil 150 upon the transmission of the electric power, or the voltage supplied to the first coil 150 from the first matching circuit 114. The thus-configured primary device 10b can activate the protection circuit 130 by the control signal, namely, the second control signal, sent from the voltage detection circuit 116 even if the control signal, namely, the first control signal, is not sent from the control circuit 100. In other words, the voltage detection circuit 116 functions as another circuit for the control-signal sending means to support the control circuit 100.

### Fourth Embodiment

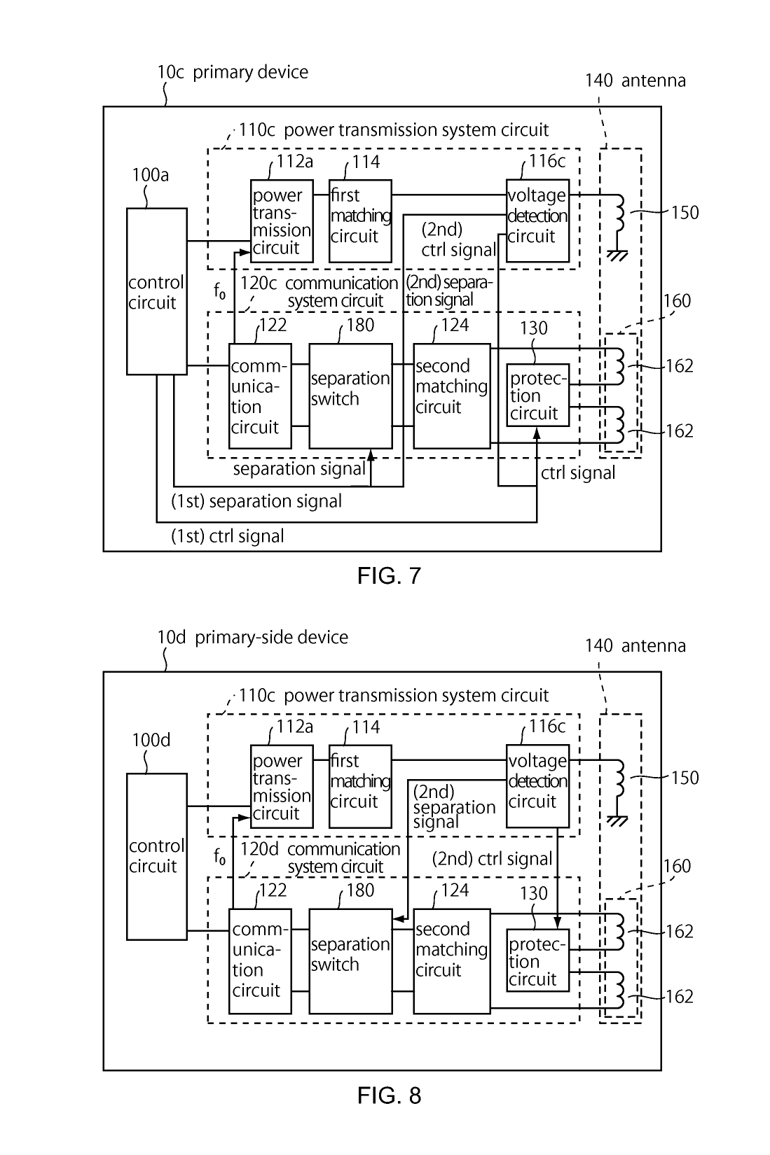

Referring to FIGS. 4, 5 and 7, a primary device (electronic device) 10c according to a fourth embodiment of the present invention is a combination, or a modification of the primary device 10a according to the aforementioned second embodiment and the primary device 10b according to the aforementioned third embodiment. In FIG. 7, components same as the components illustrated in FIG. 4 or 5 are identified by reference signs same as those in FIG. 4 or 5. In the following explanation, explanation about the same components is omitted while explanation is mainly made about some points different from the aforementioned second and third embodiments.

As shown in FIG. 7, the primary device 10c according to the present embodiment comprises a power transmission system circuit 110c and a communication system circuit 120c slightly different from the power transmission system circuit 110b and the communication system circuit 120a. In detail, the power transmission system circuit 110c includes a voltage detection circuit 116c which is connected to the separation switch 180 of the communication system circuit 120c in addition to the first matching circuit 114, the first coil 150 and the protection circuit 130. Similar to the voltage detection circuit 116 (see FIG. 5), the voltage detection circuit 116c according to the present embodiment can detect the voltage induced in the first coil 150. The voltage detection circuit 116c sends the second control signal, which is another kind of the control signal, to the protection circuit 130 of the communication system circuit 120c depending on the detected voltage (first voltage). Moreover, the voltage detection circuit 116c sends the second separation signal, which is another kind of the separation signal, to the separation switch 180 depending on a detected voltage (second voltage equal to or different from the first voltage). The second separation signal can be generated similar to the second control signal (see FIG. 6).

According to the present embodiment, the communication circuit 122 can be more securely protected, for example, when the outside strong electric power is applied.

### Fifth Embodiment

Referring to FIGS. 7 and 8, a primary device (electronic device) 10d according to a fifth embodiment of the present invention is a modification of the primary device 10c according to the aforementioned fourth embodiment. In FIG. 8, components same as the components illustrated in FIG. 7 are identified by reference signs same as those in FIG. 7. In the following explanation, explanation about the same components is omitted while explanation is mainly made about some points different from the aforementioned fourth embodiment.

As shown in FIG. 8, the primary device 10d according to the present embodiment comprises a control circuit 100d and a communication system circuit 120d slightly different from the control circuit 100a and the communication system circuit 120c. In detail, the control circuit 100d is not connected to the protection circuit 130 of the communication system circuit 120d nor the separation switch 180. As can be seen from this configuration, the control circuit 100d according to the present embodiment does not send the control signal, namely, the first control signal, nor the separation signal, namely, the first separation signal. In other words, according to the present embodiment, only the voltage detection circuit 116c is the control-signal sending means which sends the control signal, namely, the second control signal, and the separation signal, namely, the second separation signal.

According to the present embodiment, the control signal and the separation signal are completely passively sent. Accordingly, the communication circuit 122 can be prevented from being damaged by a relatively simple configuration.

The aforementioned embodiments can be modified and combined variously. For example, in the fifth embodiment, the control circuit 100d may be configured not to send the control signal, namely, the first control signal, while sending the separation signal, namely, the first separation signal. In this case, the voltage detection circuit 116c can be configured not to send the separation signal, namely, the second separation signal. Moreover, it is possible to provide another circuit which sends a third control signal and another circuit which sends a third separation signal.

The present application is based on a Japanese patent application of JP2012-174360 filed before the Japan Patent Office on Aug. 6, 2012, the contents of which are incorporated herein by reference.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

### REFERENCE NUMERALS LIST

10, 10a, 10b, 10c, 10d primary device (electronic device)

20 secondary device

22 antenna

24 communication/power-receiving circuit

26 load

100, 100a, 100d control circuit

110, 110a, 110b, 110c power transmission system circuit

112, 112a power transmission circuit

114 first matching circuit

116, 116c voltage detection circuit

118 voltage comparator

120, 120a, 120b, 120c, 120d communication system circuit

122 communication circuit

124 second matching circuit

130 protection circuit

132 switch

140 antenna

150 first coil

160 second coil

162 coil portion

164 center tap

180 separation switch

1. An electronic device comprising:
a first coil for non-contact power transmission;
a second coil for communication;
a protection circuit including a center tap of the second coil, the protection circuit opening the second coil upon receiving a control signal; and
control-signal sending means which sends the control signal to the protection circuit when the first coil is used to transmit electric power.

2. The electronic device as recited in claim 1, wherein:
the second coil has two coil portions;
the center tap is located between the two coil portions, the center tap being configured to be supplied with a fixed electric potential;
the protection circuit has at least two switches each of which is connected between one of the two coil portions and the center tap; and
the switch is configured to be turned off in response to the control signal.

3. The electronic device as recited in claim 2, wherein:
each of the switches includes an n-channel FET having a source and a gate;
the sources of the FETs of the two switches are connected to each other at a connection point;
the center tap extends from the connection point to be connected to ground; and
the control signal is to be input into the gate of the FET.

4. The electronic device as recited in claim 1, wherein:
the electronic device further comprises:
a control circuit which functions as a circuit for the control-signal sending means;
a power transmission circuit for power transmission, the power transmission circuit being connected to the control circuit;
a first matching circuit connected between the power transmission circuit and the first coil to match the power transmission circuit and the first coil with each other;
a communication circuit connected to the control circuit; and
a second matching circuit connected between the communication circuit and the second coil to match the communication circuit and the second coil with each other; and
the control circuit is configured to control the power transmission circuit and the communication circuit so that the first coil transmits the electric power and that the communication circuit communicates via the second coil, the control circuit sending a first control signal, which is a kind of the control signal, to the protection circuit when the first coil transmits the electric power.

5. The electronic device as recited in claim 4, wherein:
the electronic device comprises a voltage detection circuit which functions as another circuit for the control-signal sending means; and
the voltage detection circuit is connected to the first coil to detect a voltage induced in the first coil, the voltage detection circuit sending a second control signal, which is another kind of the control signal, to the protection circuit depending on the detected voltage.

6. The electronic device as recited in claim 4, wherein:
the electronic device further comprises a separation switch connected to the control circuit;
the power transmission circuit is configured to receive a carrier signal from the communication circuit to transmit the electric power by using the carrier signal;
when the separation switch receives a separation signal, the separation switch disconnects and separates the communication circuit from the second matching circuit; and
the control circuit outputs a first separation signal, which is a kind of the separation signal, when the electric power is transmitted.

7. The electronic device as recited in claim 6, wherein:
the electronic device comprises a voltage detection circuit; and
the voltage detection circuit is connected to the first coil to detect a voltage induced in the first coil, the voltage detection circuit sending a second separation signal, which is another kind of the separation signal, depending on the detected voltage.

8. The electronic device as recited in one of claims 1 to 3 claim 1, wherein:
the electronic device further comprises:
a control circuit;
a power transmission circuit for power transmission, the power transmission circuit being connected to the control circuit;
a first matching circuit connected between the power transmission circuit and the first coil to match the power transmission circuit and the first coil with each other;
a communication circuit connected to the control circuit;
a second matching circuit connected between the communication circuit and the second coil to match the communication circuit and the second coil with each other; and
a voltage detection circuit which functions as a circuit for the control-signal sending means;
the control circuit is configured to control the power transmission circuit and the communication circuit so that the first coil transmits the electric power and that the communication circuit communicates via the second coil; and
the voltage detection circuit is connected to the first coil to detect a first voltage induced in the first coil, the voltage detection circuit sending a second control signal, which is a kind of the control signal, to the protection circuit depending on the detected first voltage.

9. The electronic device as recited in claim 8, wherein:
the electronic device further comprises a separation switch connected to the control circuit;
the power transmission circuit is configured to receive a carrier signal from the communication circuit to transmit the electric power by using the carrier signal;
when the separation switch receives a separation signal, the separation switch disconnects and separates the communication circuit from the second matching circuit; and
the voltage detection circuit detects a second voltage induced in the first coil, the voltage detection circuit sending a separation signal, which is a kind of the separation signal, depending on the detected second voltage.

10. A system comprising:
the electronic device as recited in claim 4; and
a secondary device including a circuit configured to receive electric power from the electronic device and another circuit configured to communicate with the electronic device.

11. A system comprising:
the electronic device as recited in claim 5; and
a secondary device including a circuit configured to receive electric power from the electronic device and another circuit configured to communicate with the electronic device.

12. A system comprising:
the electronic device as recited in claim 6; and
a secondary device including a circuit configured to receive electric power from the electronic device and another circuit configured to communicate with the electronic device.

13. A system comprising:
the electronic device as recited in claim 7; and
a secondary device including a circuit configured to receive electric power from the electronic device and another circuit configured to communicate with the electronic device.

14. A system comprising:
the electronic device as recited in claim 8; and
a secondary device including a circuit configured to receive electric power from the electronic device and another circuit configured to communicate with the electronic device.

15. A system comprising:
the electronic device as recited in claim 9; and
a secondary device including a circuit configured to receive electric power from the electronic device and another circuit configured to communicate with the electronic device.
